(19) United States
(12) Patent Application Publication
(10) Pub. No.: US 2025/0385941 A1
(43) Pub. Date: Dec. 18, 2025

(54) DCF-AIDED PRIVACY-AWARE DATA SHARING

(71) Applicant: Dell Products L.P., Round Rock, TX (US)

(72) Inventors: Pankaj Pande, Carlingford (AU); Stephen J. Todd, North Andover, MA (US)

(21) Appl. No.: 18/746,474

(22) Filed: Jun. 18, 2024

(51) Int. Cl. H04L 9/40

(52) U.S. Cl. CPC H04L 63/20; H04L 63/10

(57) ABSTRACT

One example method includes identifying data to be shared by a first entity of an edge environment with a second entity of an edge environment, consulting a confidence score associated with the data, mapping the confidence score to a data policy, applying the data policy to the data, and enabling data policy-controlled access, by the second entity, to the data. The data policy specifies privacy and/or security requirements concerning the accessing and use of the data.

### TECHNOLOGICAL FIELD OF THE DISCLOSURE

### BACKGROUND

Embodiments disclosed herein generally relate to data privacy in edge environments. More particularly, at least some embodiments relate to systems, hardware, software, computer-readable media, and methods, for managing data sharing among edge entities using dynamic privacy policies based on data confidence scores.

Sharing data between various entities in edge environments often requires consideration of privacy and data protection concerns. Traditional data sharing mechanisms usually employ static, predefined privacy policies that lack the adaptiveness to factor in the data confidence levels.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a DCF (data confidence fabric) in connection with which an embodiment may implemented.

FIG. 2 discloses aspects of an architecture according to one embodiment.

FIG. 3 discloses aspects of architectures according to various embodiments.

FIG. 4 discloses a method according to one embodiment.

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to data privacy in edge environments. More particularly, at least some embodiments relate to systems, hardware, software, computer-readable media, and methods, for managing data sharing among edge entities using dynamic privacy policies based on data confidence scores, such as may be obtained from a DCF (data confidence fabric) in which the edge entities may comprise respective nodes.

One or more embodiments may comprise a method for controlling and managing data sharing and data access between, and among, edge entities, by using data sharing policies that are based on data confidence information associated with the data. One embodiment of such a method may comprise the following operation: receiving a request to access, or share, data; evaluating a confidence score associated with the data; mapping the confidence score to a privacy policy; enabling access to the data, based on the privacy policy; and, dynamically modifying the data policy when a specified change occurs to the confidence score.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may implement dynamic adaptation of data sharing policies based on changes in data confidence levels. In an embodiment, data sharing between edge entities may be dynamically controlled based on changing data confidence levels. In an embodiment, data sharing between edge entities may be dynamically controlled based on changing privacy requirements. Various other advantages of one or more example embodiments will be apparent from this disclosure.

### A. Aspects of An Example DCF (data confidence fabric)

The following is a discussion of aspects of an example DCF in connection with which an embodiment may be implemented. This discussion is not intended to limit the scope of the disclosure or claims, or the applicability of the embodiments, in any way.

In general, embodiments may be implemented in connection with systems, software, and components, that individually and/or collectively form computing environments, such as edge computing environments for example. One or more embodiments may be employed in computing environments that comprise, or implement, a portion of a data confidence fabric (DCF).

Note that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

In general, a DCF may include various nodes, which may comprise hardware and/or software, through which the data passes as the data moves through the DCF. In an embodiment, one or more of the nodes may comprise a respective edge entity that may comprise hardware and/or software. Trust information, and confidence information such as data confidence scores, or simply ‘confidence scores,’ concerning the data may be inserted at one or more of these nodes as the data transits the DCF. The trust information may indicate, for example, a relative extent to which the data may be considered trustworthy by a user of the data, such as an application for example. The confidence information may indicate a relative level of confidence in the trustworthiness of the data.

Thus, if data passes through a node that is considered untrustworthy, or at least not fully trustworthy, for some reason, the confidence in the integrity and reliability of that data may be relatively low. That is, the trust information may be a function of, for example, the nature and operation of the node(s) through which the data passes. To illustrate, if a node that handles the data is determined to have inadequate security controls, data that has passed through that node may be assessed as relatively untrustworthy and the confidence in that data may be correspondingly low. Thus, an application that may have a need for the data may consider the confidence level, or confidence score, of the data in determining whether or not to use that data.

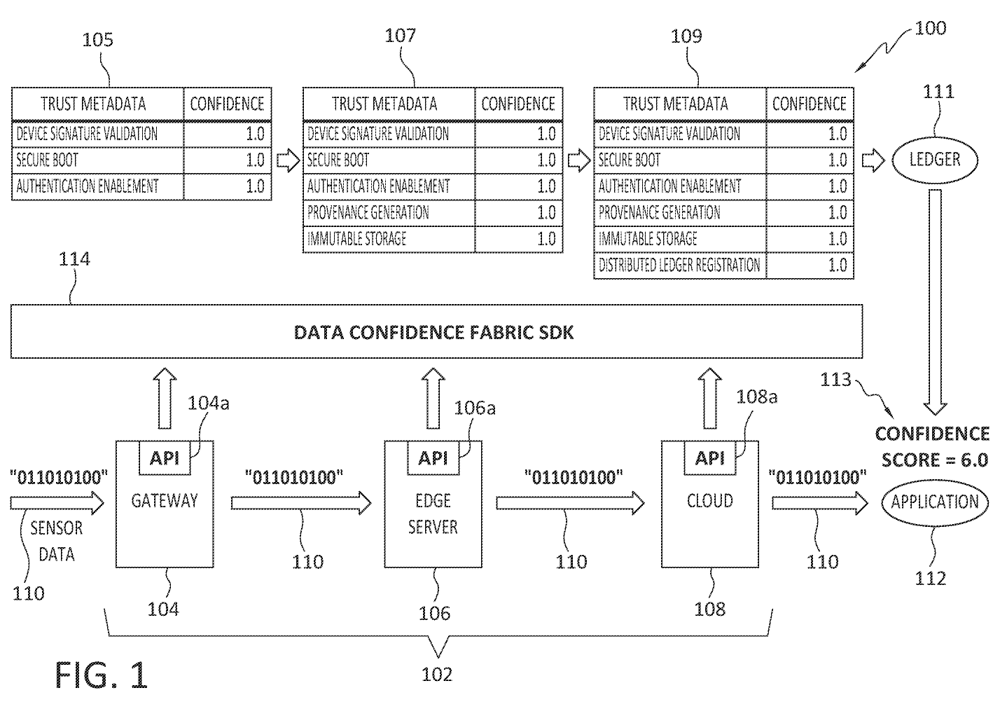

Turning now to FIG. 1, details are provided concerning an example DCF Annotation and Scoring Framework, or simply DCF, 100 in connection with which an embodiment may be employed. As shown, the DCF 100 may include various nodes 102, examples of which may include a gateway 104, an edge server 106, and a cloud site 108, through which data 110 may pass. The data 110 may ultimately be used, or consumed, by an end user 112, such as an application for example.

In an embodiment, the data 110 may be generated by a node such as a sensor, which may comprise an IoT (Internet of Things) edge device for example. Each of the nodes 102 may comprise a respective API 104a, 106a, and 108a, that the nodes 102 may use to communicate confidence information to a DCF SDK (software development kit) 112.

Consider, in the example of FIG. 1, the layers of trust that may be provided in the DCF 100. Particularly, the gateway 104 may have an embedded Intel TPM chip and it may use that chip to perform “trust services” on behalf of the owner of the data 110. In the example above, a “secure boot” annotation, in the trust metadata 105 for the gateway 104, may indicate that the gateway 104 has not been tampered with. The TPM chip may also provide keys used to perform signature services on the data 110. As well, in the example of FIG. 1, the edge server 106 may leverage an ARM secure enclave to perform a “trust service,” inspecting the data 110 and performing analytics on it. Finally, a cloud application, such as the Dell Streaming Data Platform running at the cloud site 108, may perform additional trust services on the data 110 such as, for example, inspect the data 110 for drift, as may be done if the data is coming from a sensor with a well-known range of values and/or a long history of stable behavior.

As further indicated in FIG. 1, trust metadata generated at each state of the data 110 journey may be added to trust metadata generated at upstream nodes. Thus, for example, the trust metadata 105 may have been generated at the gateway 104, and the trust metadata 107 may include both the trust metadata 105 and trust metadata generated at the edge server 106. Finally, the trust metadata 109 may include trust metadata generated at the cloud site 108, as well as the trust metadata generated at the edge server 106, and at the gateway 104.

The accumulated trust metadata 109 may be stored in an immutable ledger 111 that may be accessible by the application 112. Additionally, or alternatively, a confidence score 113 may be generated based on the trust metadata 109, and made available to the application 112 or other data 110 end user(s).

The recipient, that is, the data owner, of these trust services that insert trust metadata may require this level of trust insertion in order that their applications, such as the application 112 for example, can produce insights from the data 110 with confidence that the data 110 is trustworthy. The trust insertion functionality may be of great value because it may significantly reduce the risk of dangerous actuation or other business logic resulting from low-quality, erroneous, or malicious data. Trust services may also significantly reduce the risk of regulatory compliance violations. Preventing these violations may enable trust service recipients to avoid regulatory fines. One or more embodiments may enable the vendors providing these trust/confidence services to accurately track the provision of these services in a DCF, and an embodiment may also enable the vendor to bill the data owner, and/or other trust service consumers. Details concerning some example functionalities that may be provided by an embodiment are set forth in the following section.

### B. DCF-aided privacy-aware data sharing

### B.1 Overview

One example embodiment comprises a DCF-aided Privacy-Aware Data Sharing system (PADS) that dynamically adjusts privacy policies based on the confidence scores associated with the data. By doing so, the PADS may enhance data security and privacy while allowing for more flexible data sharing within specified confidence boundaries. A DCF-enabled edge environment generates and maintains confidence scores for all data streams between and among nodes of the edge environment. Data sharing policies may be configured to factor in data confidence scores while determining access control and data handling strategies. For example, high-confidence data may be subject to less stringent privacy controls, while lower-confidence data may be subjected to more robust protection measures, that is, measures that will help protect the data consumer with respect to any cause of the lack of confidence in the data.

Briefly then, an embodiment may comprise a dynamic privacy-aware data sharing system that incorporates data confidence scores into its policies and access control mechanisms to meet a need for adaptive privacy management in edge environments. On the other hand, conventional data sharing mechanisms and privacy policies do not account for varying levels of data confidence, or ongoing changes in data sharing policies, when determining access control rules pertaining to management of the data.

To briefly illustrate some aspects of one embodiment, consider the following use case. A collaborative smart city environment where data from multiple sources, such as traffic systems, utilities, and emergency services, is shared within a secure ecosystem. High-confidence data is shared more freely among participating entities, enabling better coordination and decision-making, while low-confidence data is subject to higher privacy restrictions to reduce potential risks.

### B.2 Discussion of aspects of an example embodiment

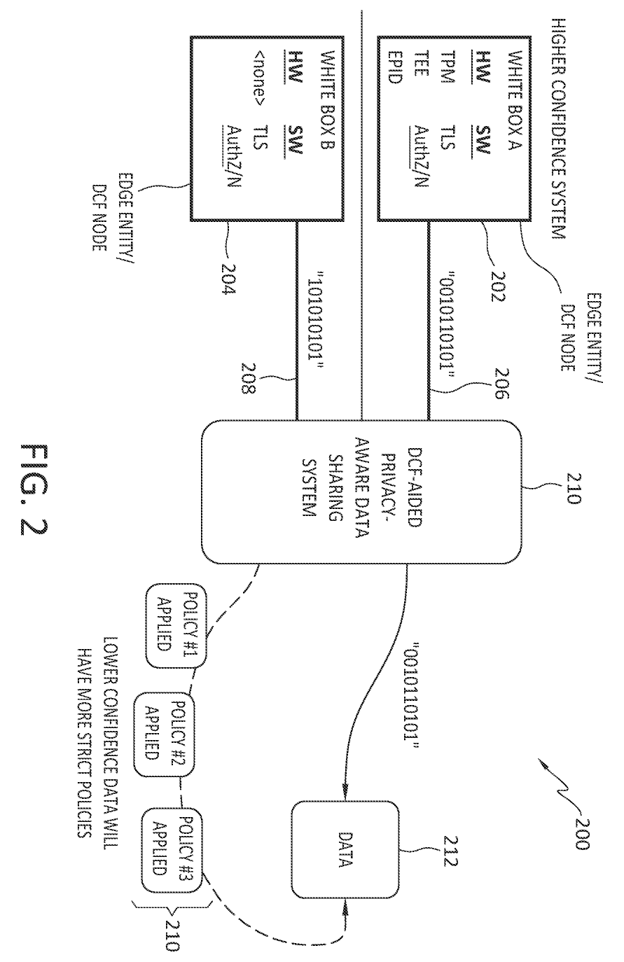

With attention now to FIG. 2, an example architecture 200 according to one embodiment is disclosed. As shown, the architecture 200 may comprise a group of edge devices, such as the edge devices 202 and 204 for example, that are configured to communicate with each other. Each of the edge devices 202 and 204 may comprise a respective node of a DCF, such that data may be passed between the edge devices 202 and 204, and respective confidence scores assigned to the data generated and/or collected by each of the edge devices 202 and 204. In an embodiment, each of the edge devices 202 and 204 assigns respective confidence scores to data that passes through it or is otherwise handled by it, that is, passes through or is otherwise handled by the edge device 202 or 204.

In the illustrative example of FIG. 2, the edge device 202 comprises various hardware security measures such as a TEE (trusted execution environment) and a TPM (trusted platform module). By comparison, the edge device 204 does not include any hardware security measures. As such, a confidence level assigned to 206 data coming from the edge device 202 may be higher than a confidence level assigned to data 208 coming from the edge device 204.

In an embodiment, the data 206 and 208, and associated confidence scores, and possibly edge-device unique identifiers, may be provided by the edge devices 202 and 204 to a PADS 210 that may include a library of data privacy policies 210 that govern the handling of the data 206 and 208. In an embodiment, the strictness of a data privacy policy 210 may be a function of the particular data in question. For example, the confidence score of the data 208 is lower than the confidence score of the data 206 and, as such, relatively stricter data privacy policies 210 may apply to the data 208, than to the data 206.

As further indicated in the example of FIG. 2, after the PADS 210 has applied data access policies and/or data control policies, such as the data privacy policies 210 for example, to one or more streams of data received by the PADS 210, the PADS 210 may store the data, tagged or otherwise associated with any applicable policies, in a data repository 212. In an embodiment, the PADS 210 may retrieve, from the data repository 212, data requested by one entity and transmit that data, to which one or more policies may have been applied, to the requesting entity. It is noted that the PADS 210 is not necessarily required to assign any policies to any particular data. The requesting entity, after receipt of the requested data, may than use the received data as controlled by any policies that have been applied to that data.

In an embodiment, a data privacy policy, which may comprise the elements of data access control and/or data handling, may be applied to data based on the intended recipient of that data. For example, private data sent to a low confidence edge entity may have strict controls applied since there may be relatively low confidence in how that low confidence edge entity can be expected to handle the data. The strict controls may ensure that, notwithstanding low confidence in the recipient, that is, the low confidence edge entity, and the data streams that the recipient generates, the any private data is unlikely to be compromised by the recipient device.

In an embodiment, data received from a low confidence edge entity may have a strict data privacy policy applied to it, since it may not be known how the data was handled by that entity, and there is a need to avoid compromising the consumer, or recipient, of that data.

In an embodiment, data transmitted between high confidence edge entities may have minimal, or even no, controls applied. In this example, there may be a relatively high level of confidence in the way that the two devices handle the data, such that it is unlikely that either of the entities would compromise the data.

In an embodiment, data transmitted between/among multiple edge entities may comprise private and/or confidential data. Examples of such data include, but are not limited to, personally identifiable information (PII), intellectual property data such as trade secrets, personal medical information, business information, national security information, and any other data and information that is not generally known or accessible.

A policy employed in an embodiment may provide a variety of different controls with respect to the handling of data. For example, a policy may specify that certain data is read-only. A policy may specify that certain data may be viewed, but not stored. A policy may specify that access to certain data will expire after a defined period of time. A policy may specify that certain data cannot be viewed, modified, or saved. A policy may specify that data cannot be copied, or forwarded to another recipient. These are provided only by way of example, and, more generally, a policy according to an embodiment may specify how certain data can be handled, and may prevent unauthorized handling of the data.

### B.3 Further embodiments

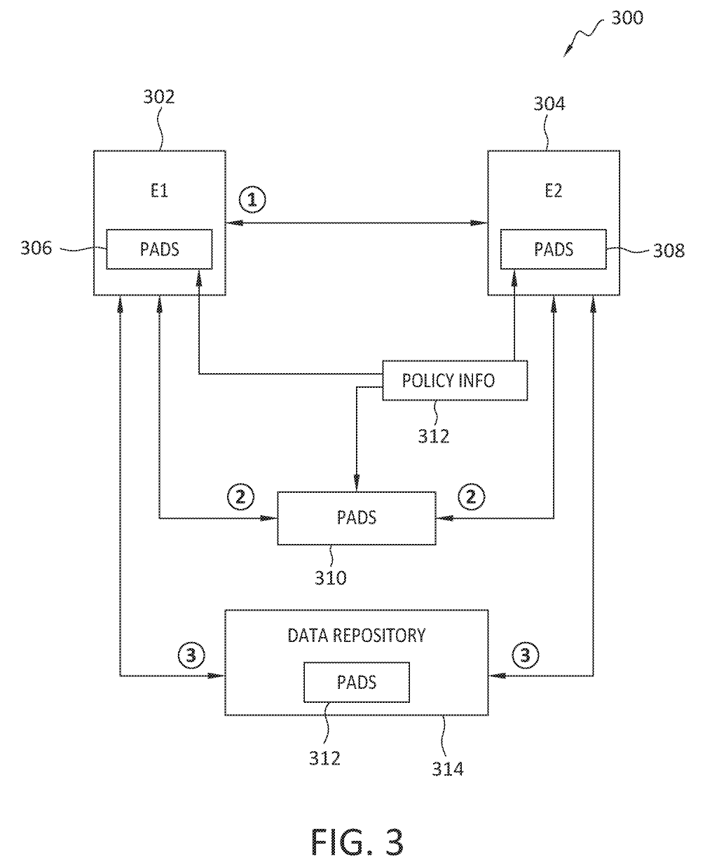

The functionalities disclosed herein may be implemented by a variety of different mechanisms. One such mechanism is disclosed in the example of FIG. 2. With attention now to FIG. 3, details are provided concerning some further examples of such mechanisms, which are collectively indicated at 300.

As shown, an architecture (1) may comprise edge entities, such as the edge entities 302 and 304. The edge entities 302 and 304 may be able to communicate directly with each other. In this example, each of the edge entities 302 and 304 may have a respective instance of a PADS 306 and 308. The PADS instances 306 and 308 may each control, according to one or more policies, the handling of data received by the edge entity 302 or 304 where the PADS instance is operating. As well, the PADS instances 306 and 308 may each apply policies to data to data that is to be transmitted by the respective edge entity 302 and 304 where the PADS instance is deployed. That is, the PADS instances 306 and 308 may each (1) apply policies to data to be transmitted by the edge entity where the PADS instance is deployed, and (2) enforce policies associated with data received by the edge entity where the PADS instance is deployed.

Various other arrangements (2) and (3) are possible. With continued reference to FIG. 3, an independent PADS platform 310 may be provided, in one embodiment (2), that is accessible by the edge entities 302 and 304. The PADS 310 platform may receive policy information 312. The policy information 312 may, in the arrangement discussed immediately above, be provided to the PADS 306 and 308. The edge device 302 may request, by way of the PADS platform 310, data from the edge device 304, and/or vice versa. The edge device 302 may thus send a request to the PADS platform 310 identifying the edge entity 304, and the data required. The PADS platform 310 may then receive the data from the edge entity 304, evaluate a confidence score associated with that data, and based on the confidence score, apply any applicable policies to that data. The data may then be transmitted by the PADS platform 310 to the edge device 302, which can then only access and use that data as specified in the applied policies.

With continued reference to FIG. 3, still another arrangement (3) may be employed. In this case, a PADS application 312 may integrated into a data repository 314 that is configured to receive, and service, data requests from the edge entities 302 and 304. In operation, the edge entity 302 may request, from the data repository 314, data stored there by the edge entity 304. Upon receipt of such a request, the PADS 312 may retrieve that data, apply any applicable policies based on a confidence score of the data, and then send the data to the edge entity 302, which can then only access and use that data as specified in the applied policies.

It is noted here that while reference is made herein to data requests, it should be appreciated that any embodiment disclosed herein may additionally, or alternatively, comprise sending data on the initiative of the sending entity. For example, the edge entity 302 may, on its own initiative, transmit data, to which one or more policies have been applied, to the edge entity 304. In this example, the edge entity 304 may not have submitted a data request, but simply received the data from the edge entity 302 at some point in time. Thus, data may be shared on request, or without a request.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

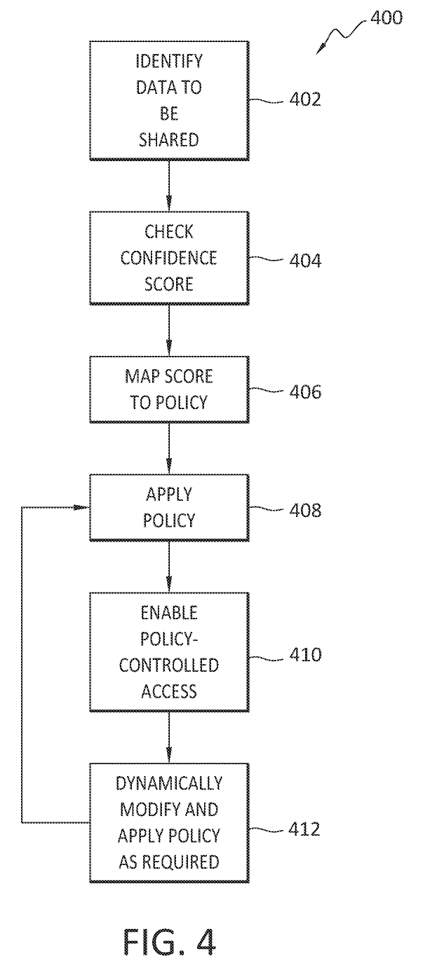

Directing attention now to FIG. 4, an example method 400 according to one embodiment is disclosed. In an embodiment, the method 400 may be performed in whole or in part by any of the disclosed PADS entities, examples of which are illustrated in FIGS. 2 and3.

The example method 400 may begin with the identification 402 of data to be shared between two edge entities. The identification 402 may be performed based on a request for data issued by an edge entity. When the data has been identified 402, a check 404 may then be performed of a confidence score associated with that data.

The confidence score may then be mapped 406 to one or more policies concerning the access and use of the data. Those policies may then be applied 408 to the data so that an edge entity that receives that data can only access and use the data as specified by the policies.

The data may then be made accessible 410 to the edge entity with which the data was intended to be shared. Finally, any policy may be dynamically updated 412, and applied to data. The updating 412 may be triggered by a change to a policy so that the updating 412 is performed automatically. In an embodiment, the updating 412 may be performed before, during, and/or after, performance of the other operations of the method 400.

### D. Further Example Embodiments

Following are some further example embodiments. These are presented only by way of example and are not intended to limit the scope of this disclosure or the claims in any way.

Embodiment 1. A method, comprising: identifying data to be shared by a first entity of an edge environment with a second entity of an edge environment; consulting a confidence score associated with the data; mapping the confidence score to a data policy; applying the data policy to the data; and enabling data policy-controlled access, by the second entity, to the data.

Embodiment 2. The method as recited in claim 1, wherein the data policy that is applied is based on the confidence score.

Embodiment 3. The method as recited in claim 1, wherein the data policy comprises a privacy requirement concerning the data.

Embodiment 4. The method as recited in claim 1, wherein the first entity and the second entity comprise respective nodes of a DCF (data confidence fabric).

Embodiment 5. The method as recited in claim 1, wherein the data policy is updated automatically in response to a change in a data access requirement concerning the data.

Embodiment 6. The method as recited in claim 1, wherein the data policy is updated automatically in response to a change in the confidence score.

Embodiment 7. The method as recited in claim 1, wherein the confidence score is a function of a trustworthiness of the first entity.

Embodiment 8. The method as recited in claim 1, wherein a lower value of the confidence score corresponds to relatively greater restrictions on use of the data than restrictions corresponding to a relatively higher value of the confidence score.

Embodiment 9. The method as recited in claim 1, wherein the confidence score was generated, and assigned to the data, by the first entity.

Embodiment 10. The method as recited in claim 1, wherein the data policy comprises a security requirement concerning the data.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

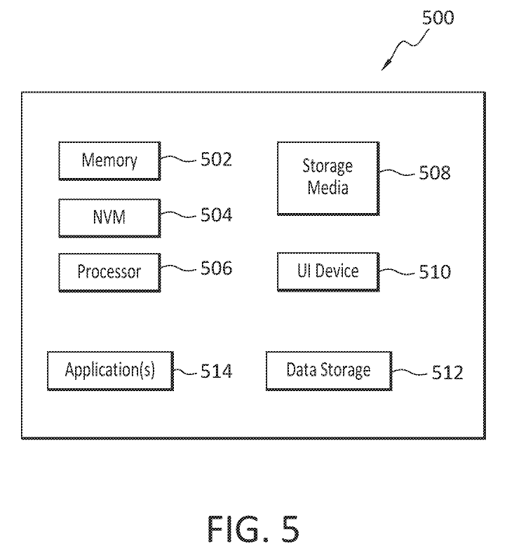

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
identifying data to be shared by a first entity of an edge environment with a second entity of an edge environment;
consulting a confidence score associated with the data;
mapping the confidence score to a data policy;
applying the data policy to the data; and
enabling data policy-controlled access, by the second entity, to the data.

2. The method as recited in claim 1, wherein the data policy that is applied is based on the confidence score.

3. The method as recited in claim 1, wherein the data policy comprises a privacy requirement concerning the data.

4. The method as recited in claim 1, wherein the first entity and the second entity comprise respective nodes of a DCF (data confidence fabric).

5. The method as recited in claim 1, wherein the data policy is updated automatically in response to a change in a data access requirement concerning the data.

6. The method as recited in claim 1, wherein the data policy is updated automatically in response to a change in the confidence score.

7. The method as recited in claim 1, wherein the confidence score is a function of a trustworthiness of the first entity.

8. The method as recited in claim 1, wherein a lower value of the confidence score corresponds to relatively greater restrictions on use of the data than restrictions corresponding to a relatively higher value of the confidence score.

9. The method as recited in claim 1, wherein the confidence score was generated, and assigned to the data, by the first entity.

10. The method as recited in claim 1, wherein the data policy comprises a security requirement concerning the data.

11. A non-transitory storage medium having stored therein instructions that are executable by one or more hardware processors to perform operations comprising:
identifying data to be shared by a first entity of an edge environment with a second entity of an edge environment;
consulting a confidence score associated with the data;
mapping the confidence score to a data policy;
applying the data policy to the data; and
enabling data policy-controlled access, by the second entity, to the data.

12. The non-transitory storage medium as recited in claim 11, wherein the data policy that is applied is based on the confidence score.

13. The non-transitory storage medium as recited in claim 11, wherein the data policy comprises a privacy requirement concerning the data.

14. The non-transitory storage medium as recited in claim 11, wherein the first entity and the second entity comprise respective nodes of a DCF (data confidence fabric).

15. The non-transitory storage medium as recited in claim 11, wherein the data policy is updated automatically in response to a change in a data access requirement concerning the data.

16. The non-transitory storage medium as recited in claim 11, wherein the data policy is updated automatically in response to a change in the confidence score.

17. The non-transitory storage medium as recited in claim 11, wherein the confidence score is a function of a trustworthiness of the first entity.

18. The non-transitory storage medium as recited in claim 11, wherein a lower value of the confidence score corresponds to relatively greater restrictions on use of the data than restrictions corresponding to a relatively higher value of the confidence score.

19. The non-transitory storage medium as recited in claim 11, wherein the confidence score was generated, and assigned to the data, by the first entity.

20. The non-transitory storage medium as recited in claim 11, wherein the data policy comprises a security requirement concerning the data.
